(19) United States
(12) Patent Application Publication
(10) Pub. No.: US 2023/0296812 A1
(43) Pub. Date: Sep. 21, 2023

(54) OPTICAL WAVEGUIDE

(71) Applicant: Snap Inc., Santa monica, CA (US)

(72) Inventors: Jonathan Paul Freeman, Rochester (GB); Rory Thomas Alexander Mills, Rochester (GB)

(21) Appl. No.: 18/042,147

(22) PCT Filed: Aug. 16, 2021
(86) PCT No.: PCT/GB2021/052118

§ 371 Date: Feb. 17, 2023

(30) Foreign Application Priority Data
Aug. 20, 2020 (EP) 20275133.5
Aug. 20, 2020 (GB) 2012986.2

(51) Int. Cl. G02B 1/18; F21V 8/00; G02B 27/01

(52) U.S. Cl. CPC G02B 1/18; G02B 6/0093; G02B 6/0016; G02B 27/0172

(57) ABSTRACT

In various embodiments, the disclosed subject-matter includes an optical waveguide for a look-through display is disclosed. The optical waveguide includes a light guiding layer and an anti-contaminant layer. The anti-contaminant layer has substantially no impact on the total internal reflection of light at an interface of the light guiding layer. Other devices and apparatuses are also disclosed.

### BACKGROUND

Optical waveguides may be used in many applications, such as head up displays (HUD), head mounted displays (HMD), and other wearable displays. The optical waveguide in many applications is substantially transparent, such that a user can see a virtual image overlain with real life scenery.

### BRIEF DESCRIPTION OF DRAWINGS

FIGS. 1a and 1b illustrate a simple waveguide.

FIGS. 2a and 2b illustrate an optical waveguide according to some examples.

FIG. 3 illustrates a protected optical waveguide according to some examples.

FIG. 4 illustrates a waveguide according to some examples.

### DETAILED DESCRIPTION

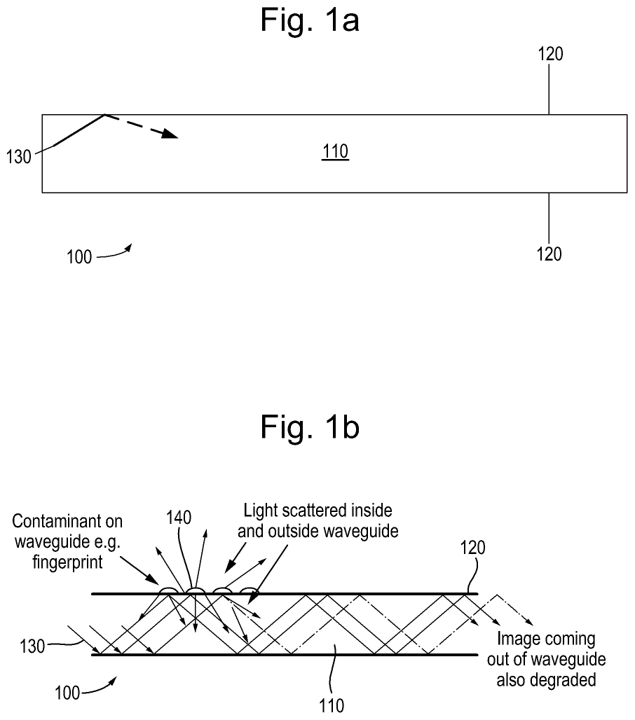

FIG. 1a illustrates a simple waveguide 100. The simple waveguide 100 comprises a light guiding layer 110, and an air-waveguide interface 120. The bandwidth of light trapped in the waveguide by total internal reflection (TIR) is limited by the refractive index of the waveguide material (n_{substrate}) and air (nₐᵢᵣ) and is defined by

$${θ}_{c} = arcsin ( \frac{{n}_{air}}{{n}_{substrate}} ) . \qquad ( 1 )$$

Which, for refractive index values of 1.0 for air and 1.8 for the substrate gives a bandwidth within the waveguide limited to angles ≥33.75°.

FIG. 1b illustrates a scenario where the simple waveguide 100 comprises a contaminant 140 on the air-waveguide interface 120. The presence of contaminants 140 on the air-waveguide 120 may cause the interface to be modified, effectively reducing the difference in refractive index and therefore reducing the bandwidth of the simple waveguide 100. This may cause scattering of light both inside and outside the simple waveguide 100 and may cause a degraded image received by the user of the simple waveguide 100. Furthermore, light scattered out of the simple waveguide 100 may reduce the efficiency of the waveguide and the scattered light may be observed by the user. The contaminants may comprise materials introduced onto the simple waveguide 100 from finger prints, such as dust, oil, or skin particles.

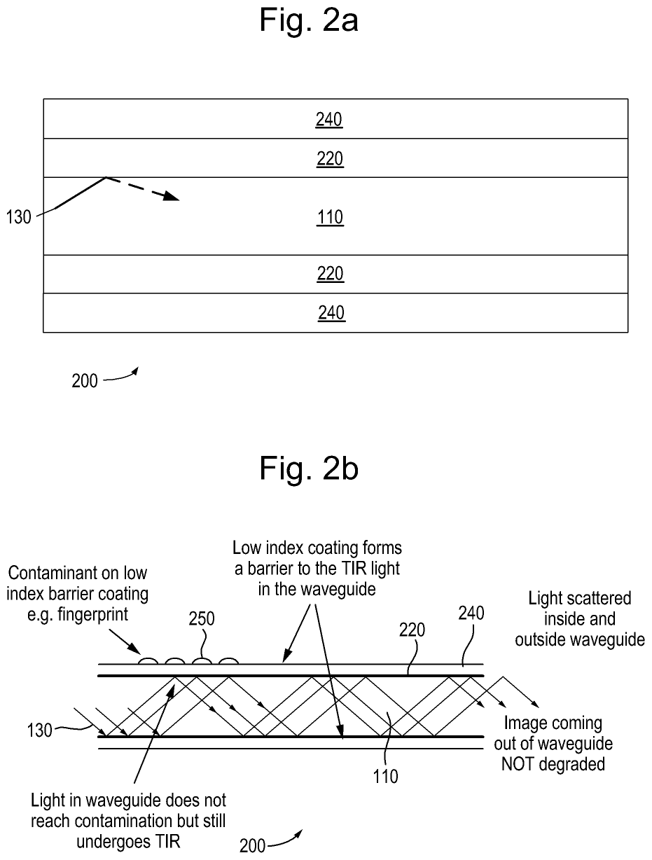

FIG. 2a illustrates an optical waveguide 200 according to some examples. The optical waveguide 200 comprises a light guiding layer 110, a coating-waveguide interface 220 and an anti-contaminant layer 240. The anti-contaminant layer 240 protects the waveguide against the presence of contaminants by moving the TIR interface away from the surface which the contaminants may reach.

The properties of the anti-contaminant layer 240 are chosen such that they have little or no impact on the TIR characteristics of the light guiding layer 110 compared to the situation where there is merely an air-waveguide interface. Light 130 is input into the waveguide, and is reflected at the coating-waveguide interface 220 undergoing TIR. As the reflection takes place substantially at the coating-waveguide interface 220 any contaminants on the surface of the anti-contaminant layer 240 have substantially zero effect on the propagation of light in the waveguides. This results in no degradation of the image received by the user of the optical waveguide 200 even if there are contaminants on the anti-contaminant layer 240.

This is illustrated by FIG. 2b, which shows how contaminant 250 does not impact the TIR of light, in comparison with FIG. 1b.

According to some examples the light guiding layer 110 may have a refractive index (n_{substrate}) equal to 1.8 and the refractive index (n_{coating}) of the anti-contaminant layer may be 1.2. The bandwidth within the waveguide may be defined by

$${θ}_{c} = arcsin ( \frac{{n}_{coating}}{{n}_{substrate}} ) . \qquad ( 2 )$$

Leading to the bandwidth ≥41.8°. Equation 2 is similar to equation 1, except that the nₐᵢᵣ is replaced by n_{coating}. Although the bandwidth is now lower than the waveguide without the coating applied, the waveguide performance is still improved as the anti-contaminant layer protects the optical waveguide 200 from contaminants.

The reduction in bandwidth may be mitigated by choosing a substrate having a higher refractive index, or anti-contaminant coating with lower refractive index. If the refractive index of the light guiding layer 110 is equal to 2.0 and the coating is 1.2, then the bandwidth ≥36.9°.

The anti-contaminant layer 240 may comprise a material having a refractive index that is close to that of air. In some examples the refractive index of the anti-contaminant layer 240 may be substantially between 1.0 and 1.5, however it is not limited to these values, and as explained above a lower refractive index of the anti-contaminant coating is preferable. In some examples the refractive index may between 1.1 and 1.3. In some examples it may be between 1.15 and 1.25. A material comprising such a refractive index may comprise a polymer. In some examples the polymer comprises a porous structure. In some examples the polymer may comprise a polymer supplied by Inkron. For example the coating may comprise a siloxane-based coating, such as IOC-560 as supplied by Inkron.

The thickness of the anti-contaminant layer 240 may be controlled to limit evanescent coupling out of the anti-contaminant layer 240. This thickness is dependent upon wavelength and other properties of the anti-contaminant layer 240. In some examples the thickness of the anti-contaminant layer 240 may be at least 1 μm.

The optical waveguide 200 may be used to present an image to a user in see-through displays, such as HUD or HMD. Therefore the optical waveguide 200 may be required to be substantially transparent to visible wavelengths of light, such that a user may observe the outside world, overlain with the displayed image, through the optical waveguide 200. In some examples therefore, the Visible Light Transmission (VLT) of the optical waveguide 200 is greater than or equal to 75%, and in some examples may be greater than or equal to 90%. Examples of the anti-contaminant layer 240 may therefore have a VLT greater than or equal to 80%, and in some examples may be greater than or equal to 95%.

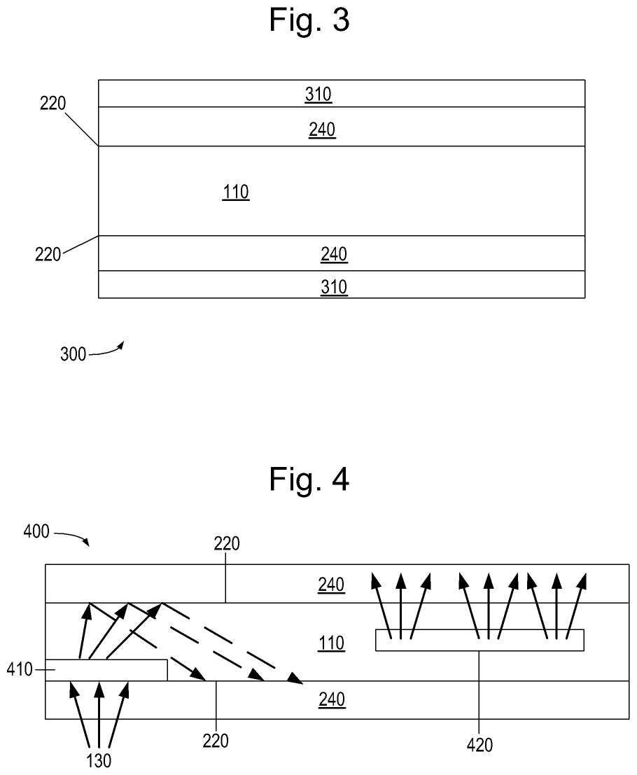

FIG. 3 illustrates a protected optical waveguide 300. Protected optical waveguide 300 is substantially similar to optical waveguide 200 and comprises a light guiding layer 110, a coating-waveguide interface 220 and an anti-contaminant layer 240. Protected optical waveguide 300 also comprises a protective layer 310 bonded to the anti-contaminant layer 240. This may be to protect the anti-contaminant layer 240 from damage, as some anti-contaminant layers 240 may not be robust.

The presence of the anti-contaminant layer 240 allows for the refractive index of the protective layer 310 to be higher or equal to the anti-contaminant layer or the light guiding layer. This is because light 130 is reflected at the coating-waveguide interface 220, and so any material on the anti-contaminant layer will have substantially no impact on the containment of the waveguide. Without the anti-contaminant layer 240 an air gap is required before any protective layer 310, as otherwise light would no longer undergo TIR.

In some examples the protective layer 310 may be bonded to the waveguide using an optically transparent glue. The protective layer 310 is not required to be flat.

The protected waveguide 300 may also be used to present an image to a user in see-through displays, such as HUD or HMD, and therefore may be required to be substantially transparent to visible wavelengths of light, such that a user may observe the outside world, overlain with the displayed image, through the optical waveguide 200.

In some examples the optical waveguide 200 or protected waveguide 300 may comprise surface relief gratings. Applying an anti-contaminant layer 240 to the surface relief coating may also enhance the performance of the grating, such as more accurately controlling the efficiency of the grating.

FIG. 4 illustrates a waveguide 400 according to some examples. Waveguide 400 comprises a light guiding layer 110 and an anti-contaminant layer 240. TIR happens at the coating-waveguide interface 220. Light 130 is coupled into the waveguide 400 with a range of field angles via input diffractive element 410 which diffracts the light 130 into the waveguide under TIR in a second range of field angles at the coating-waveguide interface 220. The light is then diffracted out of the waveguide by second diffractive element 420 to the original range of angles.

FIG. 4 illustrates the first diffractive element 410 as being a surface relief grating, however it is to be understood that the first diffractive element 410 may comprise a surface or an embedded grating. Furthermore, the grating may operate in a reflective mode or a transmissive mode.

FIG. 4 illustrates the second diffractive element 420 as being an embedded grating, however it is to be understood that the second diffractive element 420 may comprise a surface relief grating or an embedded grating. Furthermore, the grating may operate in a reflective mode or a transmissive mode.

Additional substrates may be bonded onto the exterior surfaces of waveguide 400.

In some examples the grating pitch of the gratings may be 400 nm and the source wavelength of light may be 532 nm. The source total field of view may be 30° such that the range of field angles in air are ±15°. The refractive index of the substrate may be 1.8, such that the range of the field angles in the substrate may be ±8.3°. After the passing through the first diffractive element 410 the range of field angles in the substrate is +36.3° to +61.6°. therefore, in order to enable optical isolation the n_{coating} should be sufficiently low such that the field of view bandwidth is maintained.

Rearranging equation 2 leads to

n_{coating}=n_{substrate} sin(θ_{c}) (3)

Such that n_{coating} should be less than or equal to 1.07. A material comprising such a refractive index may comprise a polymer. In some examples the polymer comprises a porous structure. In some examples the polymer may comprise a siloxane-based polymer supplied by Inkron.

1. An optical waveguide comprising:
a light guiding layer, an input diffractive element comprising a surface relief grating formed on the light guiding layer, and an anti-contaminant layer, which at least partially covers the surface relief grating, the anti-contaminant layer being configured to have substantially no impact on the total internal reflection of light at an interface of the light guiding layer over a desired field-angle bandwidth, the refractive index of the anti-contaminant layer being approximately equal to a product of the refractive index of the light guiding layer multiplied by the sine of the desired field-angle bandwidth inside the light guiding layer, and a thickness of the anti-contaminant layer is greater than about 1 μm.

2. The optical waveguide according to claim 1, wherein a refractive index of the anti-contaminant layer is between approximately 1.0 and 1.5.

3. The optical waveguide according to claim 1, wherein a refractive index of the anti-contaminant layer is between approximately 1.1 and 1.3.

4. (canceled)

5. The optical waveguide according to claim 1, wherein the anti-contaminant layer comprises a polymer layer.

6. The optical waveguide according to claim 1, wherein the anti-contaminant layer comprises a protective layer bonded to the anti-contaminant layer.

7. The optical waveguide according to claim 6, wherein the refractive index of the protective layer is greater than the refractive index of the anti-contaminant layer.

8. The optical waveguide according to claim 6, wherein there is substantially no air gap between the protective layer and the anti-contaminant layer.

9. (canceled)

10. (canceled)

11. The optical waveguide according to claim 1, wherein the anti-contaminant layer is substantially transparent with a visible light transmission of at least about 80%.

12. The optical waveguide according to claim 1, wherein the anti-contaminant layer is substantially transparent with a visible light transmission of at least about 95%.

13. A head-up display comprising:
a light-guiding layer; and
an anti-contaminant layer formed on at least one side of the light-guiding layer and being configured to have substantially no impact on a total internal reflection of light at an interface of the light guiding layer over a desired field-angle bandwidth.

14. The head-up display of claim 13, wherein the refractive index of the anti-contaminant layer is approximately equal to a product of the refractive index of the light-guiding layer multiplied by the sine of the desired field-angle bandwidth inside the light-guiding layer.

15. The head-up display of claim 13, wherein a thickness of the anti-contaminant layer is greater than about 1 μm.

16. The head-up display of claim 13, further comprising an input diffractive element comprising a surface relief grating formed on the light-guiding layer, wherein the anti-contaminant layer at least partially covers the surface relief grating.

17. The head-up display of claim 13, wherein the head-up display comprises a head-mounted display.

18. An optical waveguide, comprising:
a light-guiding layer; and
an the anti-contaminant layer formed on at least one side of the light-guiding layer, the anti-contaminant layer being configured such that any contaminants on a surface of the anti-contaminant layer have substantially no effect on a propagation of light with the light-guiding layer.

19. The optical waveguide of claim 18, wherein the anti-contaminant layer comprises a material having a refractive index close to that of air.

20. The optical waveguide of claim 18, wherein the anti-contaminant layer comprises a material comprising a polymer having a porous structure.
